(19) United States
(12) Patent Application Publication
(10) Pub. No.: US 2025/0199266 A1
(43) Pub. Date: Jun. 19, 2025

(54) OPTICAL ELEMENT DRIVING MECHANISM

(71) Applicant: TDK TAIWAN CORP., Taoyuan City (TW)

(72) Inventors: Ying-Jen WANG, Taoyuan City (TW); Yi-Ho CHEN, Taoyuan City (TW); Ya-Hsiu WU, Taoyuan City (TW)

(21) Appl. No.: 18/978,558

(22) Filed: Dec. 12, 2024

Related U.S. Application Data
(60) Provisional application No. 63/609,529, filed on Dec. 13, 2023.

(51) Int. Cl. G02B 7/09; G02B 27/64

(52) U.S. Cl. CPC G02B 7/09; G02B 27/646

(57) ABSTRACT

An optical element driving mechanism is provided, which includes a movable portion, a fixed portion, and a driving assembly. The movable portion is used for connecting an optical element. The movable portion is movable relative to the fixed portion. The driving assembly is used for driving the movable portion to move relative to the fixed portion.

### CROSS REFERENCE TO RELATED APPLICATIONS

This application claims priority of U.S. Provisional Patent Application No. 63/609,529 filed on Dec. 13, 2023, the entirety of which is incorporated by reference herein.

### BACKGROUND OF THE INVENTION

### Field of the Invention

The present disclosure relates to an optical element driving mechanism.

### Description of the Related Art

As technology has developed, it has become more common to include image-capturing and video-recording functions into many types of modern electronic devices, such as smartphones and digital cameras. These electronic devices are used more and more often, and new models have been developed that are convenient, thin, and lightweight, offering more choice to consumers.

Electronic devices that have image-capturing or video-recording functions normally include a driving mechanism to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY OF THE INVENTION

An optical element driving mechanism is provided in some embodiments of the present disclosure, which includes a movable portion, a fixed portion, and a driving assembly. The movable portion is used for connecting an optical element. The movable portion is movable relative to the fixed portion. The driving assembly is used for driving the movable portion to move relative to the fixed portion.

In some embodiments, the optical element driving mechanism further includes a first supporting assembly, wherein: the movable portion is movable relative to the fixed portion in a first dimension through the first supporting assembly. The first supporting assembly includes: a first moving portion, a first contact portion movable relative to the first moving portion and in contact with the first moving portion, a second contact portion movable relative to the first moving portion and in contact with the first moving portion, a second moving portion, and a third contact portion movable relative to the second moving portion and in contact with the second moving portion.

In some embodiments, a connection between centers of the first contact portion and the second contact portion is defined as a first virtual line. The first contact portion and the second contact portion are arranged along a first axis. The first moving portion and the second moving portion do not overlap each other in a direction that the first axis extends. The first moving portion and the second moving portion at least partially overlap each other in a direction that a second axis extends. The first moving portion and the second moving portion do not overlap each other in a direction that a third axis extends.

In some embodiments, the first axis and the second axis are not parallel. The first axis and the third axis are not parallel. The second axis and the third axis are not parallel.

In some embodiments, the optical element driving mechanism further includes a first force-applying element, a second force-applying element corresponding to the first force-applying element to generate a first leaning force, and a third force-applying element corresponding to the first force-applying element to generate a second leaning force.

In some embodiments, a center of the second force-applying element is between the first virtual line and a center of the movable portion in the direction that the second axis extends. The center of the second force-applying element is in a triangle formed by centers of the first contact portion, the second contact portion, and the third contact portion when viewed along the third axis.

In some embodiments, a shortest distance between a center of the third force-applying element and the center of the movable portion is different from a shortest distance between the center of the second force-applying element and the center of the movable portion in the direction that the second axis extends. A shortest distance between the first force-applying element and the second force-applying element is different from a shortest distance between the first force-applying element and the third force-applying element in the direction that the third axis extends.

In some embodiments, the first axis is perpendicular to the second axis. The first axis is perpendicular to the third axis. The second axis is perpendicular to the third axis.

In some embodiments, the shortest distance between the center of the third force-applying element and the center of the movable portion is less than the shortest distance between the center of the second force-applying element and the center of the movable portion in the direction that the second axis extends. The shortest distance between the first force-applying element and the second force-applying element is less than the shortest distance between the first force-applying element and the third force-applying element in the direction that the third axis extends. The second force-applying element and the third force-applying element do not overlap each other in the direction that the third axis extends.

In some embodiments, the optical element driving mechanism further includes a first circuit element and a first adhesive element, wherein: the first circuit element is electrically connected to the driving assembly. The second force-applying element is between the first force-applying element and the first circuit element when viewed along the first axis. The second force-applying element connects to the first circuit element through the first adhesive element. The first adhesive element includes metal.

In some embodiments, the optical element driving mechanism further includes a second adhesive element. Electrical signal in the first circuit element does not pass through the second force-applying element. The second force-applying element is electrically isolated from the driving assembly. The second force-applying element includes metal. The third force-applying element connects to the first circuit element through the second adhesive element. The second adhesive element includes resin. The third force-applying element includes metal.

In some embodiments, an area of the second force-applying element is different from an area of the third force-applying element when viewed along the third axis. A maximum size of the second force-applying element in the third axis is different from a maximum size of the third force-applying element in the third axis.

In some embodiments, the driving assembly includes a first coil, a first magnetic element having a first magnetic element surface facing the first coil, and having a first pair of poles arranged along a first pole direction, a second magnetic element adjacent to the first magnetic element and having a second pair of poles arranged along a second pole direction, and a third magnetic element having a third pair of poles arranged along a third pole direction.

In some embodiments, the first pole direction is not parallel to the first magnetic element surface. The second pole direction is not parallel to the first pole direction. The second magnetic element is affixed on the first magnetic element. A second magnetic element surface of the second magnetic element faces the first magnetic element. The first pole direction and the third pole direction are parallel and opposite.

In some embodiments, the optical element driving mechanism further includes a first connecting element, wherein the first magnetic element is affixed on the second magnetic element through the first connecting element, and a first reinforcement element includes metal and corresponds to the first magnetic element.

In some embodiments, the first connecting element is located at an intersection between the first magnetic element and the second magnetic element. The center of the first magnetic element is between the first connecting element and the first magnetic element surface. The first connecting element connects to the first reinforcement element. The first connecting element is in a first opening of the first reinforcement element. The first reinforcement is magnetic permeable.

In some embodiments, the optical element driving mechanism further includes a second connecting element connects to the first magnetic element. The first connecting element and the second connecting element are arranged along a direction parallel to the first magnetic element surface. The second connecting element is in a second opening of the first reinforcement element.

In some embodiments, the second connecting element connects to the first reinforcement element. The second magnetic element at least partially overlaps the first coil in a direction perpendicular to the first magnetic element surface.

In some embodiments, the driving assembly further includes a third coil and a seventh magnetic element corresponding to the third coil. The seventh magnetic element is movable relative to the first magnetic element. The first magnetic element and the seventh magnetic element are disposed on different sides of the fixed portion having a polygonal shape when viewed in the direction perpendicular to the first magnetic element surface.

In some embodiments, the optical element driving mechanism further includes a position sensing assembly, a first circuit element, and a second force-applying element. The position sensing assembly is used for detecting movement of the optical element. The position sensing assembly includes a first position sensor. The movable portion and the fixed portion are arranged along a first axis. The first position sensor and the second force-applying element are arranged along a second axis. The first axis and the second axis are perpendicular. The first position sensor is disposed on the first circuit element.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of the optical element driving mechanism.

FIG. 1B is an exploded view of the optical element driving mechanism.

FIG. 1C is a top view of the optical element driving mechanism.

FIG. 2A is a cross-sectional view taken along line A-A of FIG. 1C.

FIG. 2B is a cross-sectional view taken along line B-B of FIG. 1C.

FIGS. 3A, 3B, and 3C are top views of some elements of the optical element driving mechanism.

FIG. 3D is an enlarged view of the area shown in FIG. 3C.

FIG. 4 is a side view of some elements of the optical element driving mechanism.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may further include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may further include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

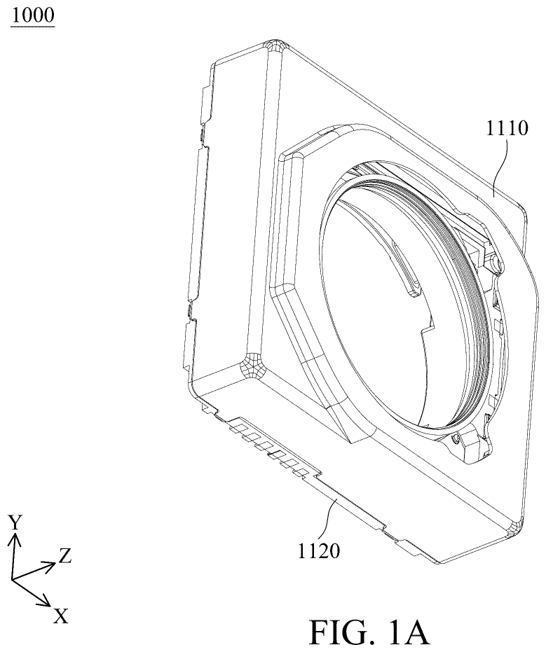

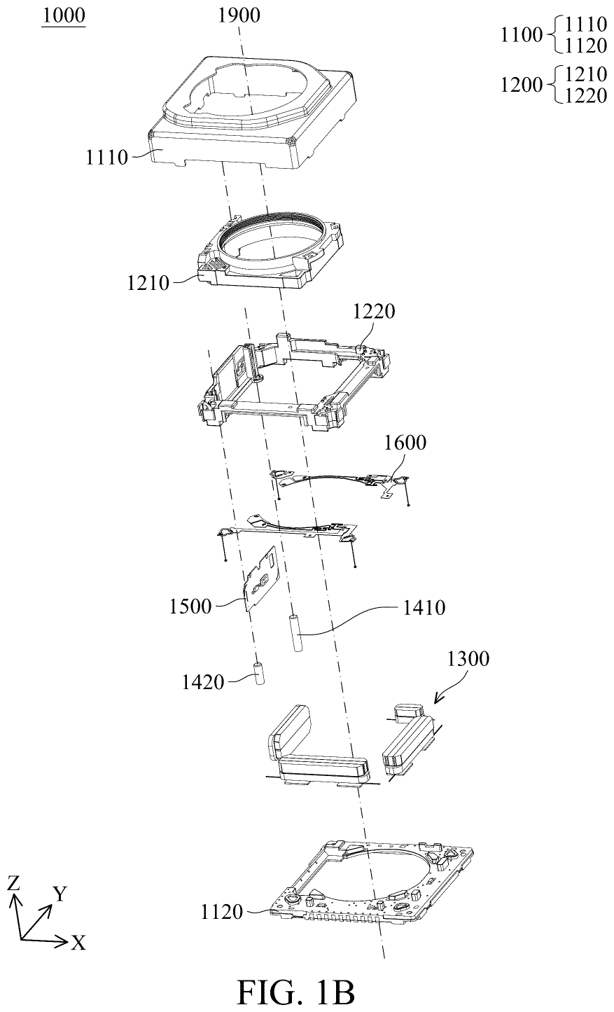

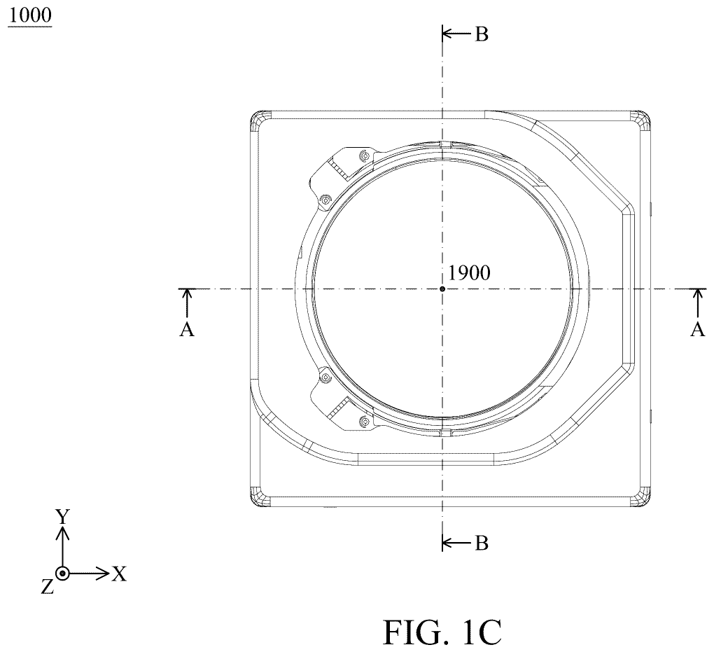

Embodiments of the present disclosure disclose an optical element driving mechanism used for driving an optical element to move. For example, FIG. 1A is a schematic view of an optical element driving mechanism 1000. FIG. 1B is an exploded view of the optical element driving mechanism 1000. FIG. 1C is a top view of the optical element driving mechanism 1000.

As shown in FIG. 1A to FIG. 1C, the optical element driving mechanism 1000 may mainly include a fixed portion 1100 (which includes a frame 1110 and a bottom 1120), a movable portion 1200 (which includes a holder 1210 and a frame 1220), a driving assembly 1300, a first moving portion 1410, a second moving portion 1420, a first circuit element 1500, and a resilient element 1600 arranged along a main axis 1900 and used for driving an optical element (not shown) to move.

In some embodiments, the optical element may be disposed on the holder 1210, and may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the frame 1110 and the bottom 1120 of the fixed portion 1100 may be combined together to form a shell of the optical element driving mechanism 1000, and other elements of the optical element driving mechanism 1000 may be disposed in the shell formed by the frame 1110 and the bottom 1120 to protect these elements. For example, the bottom 1120 may be affixed on the frame 1110. In some embodiments, additional circuit may be embedded in the bottom 1120 to allow the elements in the frame 1110 to electrically connect to other elements.

In some embodiments, the holder 1210 and the frame 1220 of the movable portion 1200 may be disposed in the fixed portion 1100 and may move relative to the fixed portion 1100. In other words, the holder 1210 and the frame 1220 are movably connected to the fixed portion 1100. Furthermore, the holder 1210 may move relative to the frame 1220 as well.

In some embodiments, the driving assembly 1300 may be used for driving the holder 1210 and the frame 1220 to move relative to the fixed portion 1100 to achieve auto focus (AF) or optical image stabilization (OIS).

In some embodiments, the first circuit element 1500 may be, for example, a printed circuit board (PCB), and may be disposed on the frame 1220, such as affixed on the frame 1220 by adhesion. The first circuit element 1500 is used for electrically connecting to other elements (such as the driving assembly 1300) in the optical element driving mechanism 1000 and external devices to provide electrical signal. Therefore, the movement of the movable portion 1200 in the X, Y, and Z axes may be controlled to achieve auto focus or optical image stabilization. The driving assembly 1300 may be affixed on the first circuit element 1500 by adhesion.

In some embodiments, the resilient element 1600 may include metal, and may be disposed between the fixed portion 1100 and the movable portion 1200 to allow the movable portion 1200 movably connected to the fixed portion 1100. Therefore, the holder 1210 and the optical element disposed on the holder 1210 may move relative to the fixed portion 1100. Furthermore, the resilient element 1600 may be electrically connected to the circuit embedded in the bottom 1120 to electrically connect to other electronic elements of the optical element driving mechanism 1000. For example, the resilient element 1600 may include a spring plate perpendicular to the Z axis and a spring wire parallel to the Z axis, the spring plate may be disposed on one side of the movable portion 1200, and the spring wire may extend across the movable portion 1200 to transfer the signal from one side of the movable portion 1200 to another side of the movable portion 1200, such as transfer to the circuit embedded in the bottom 1120.

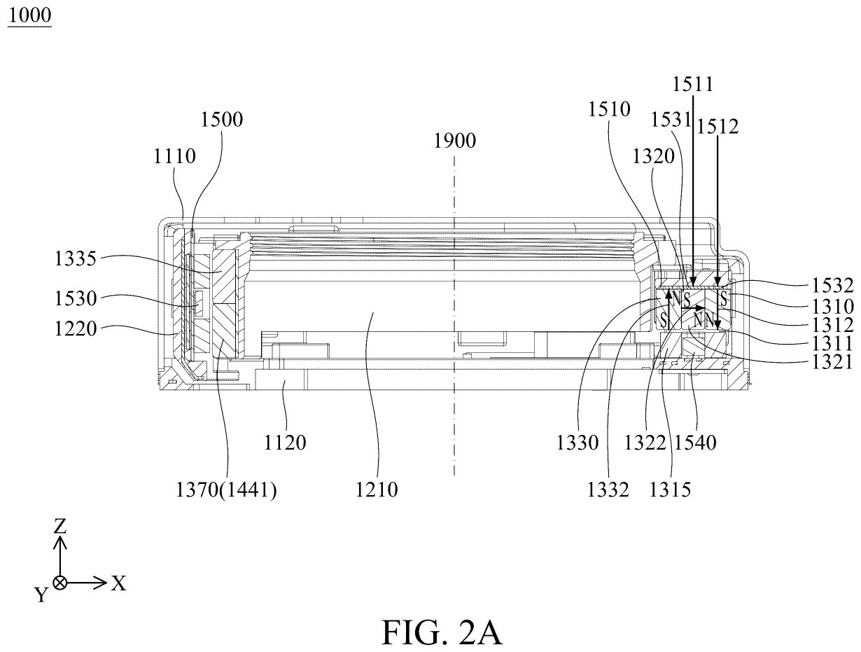

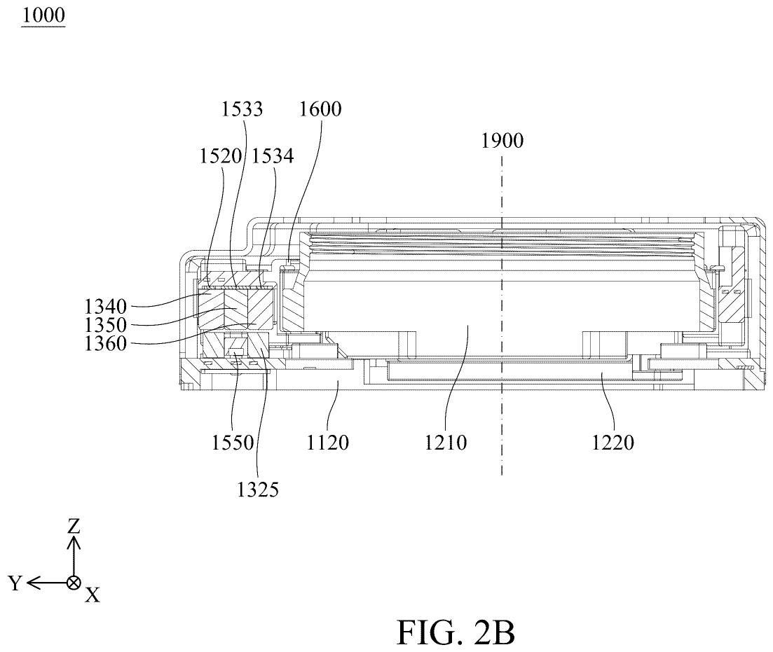

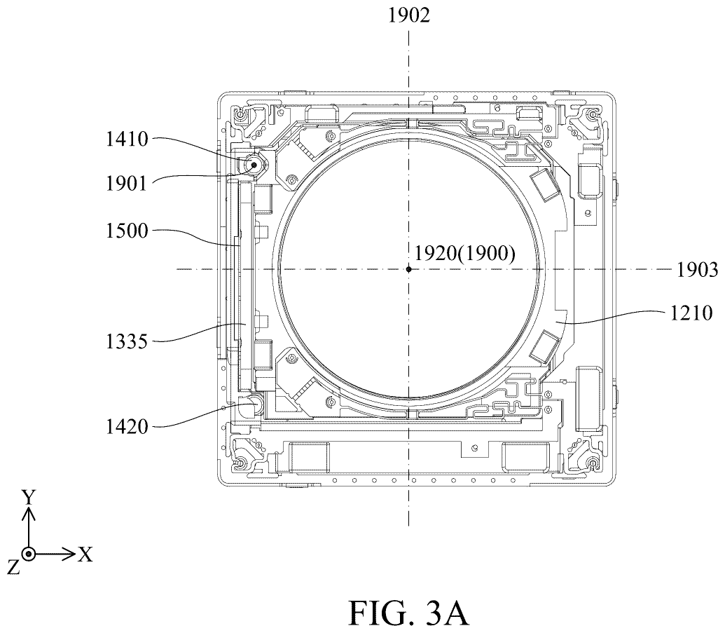

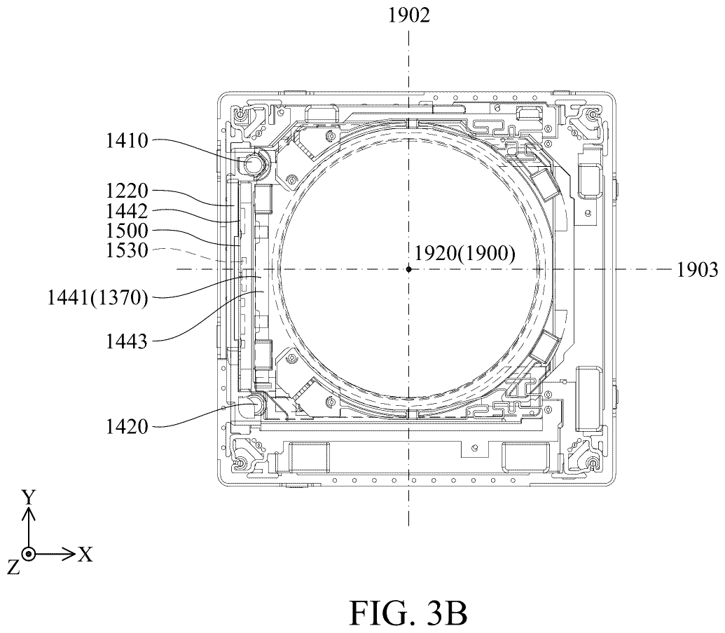

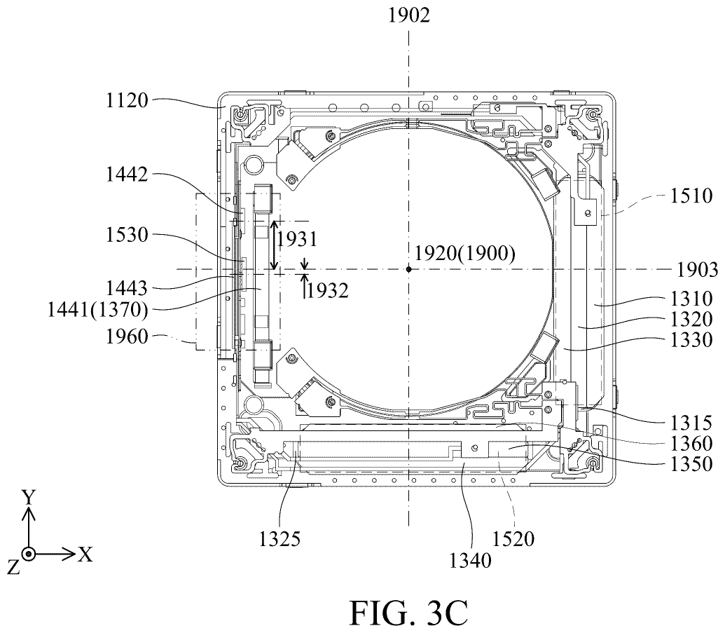

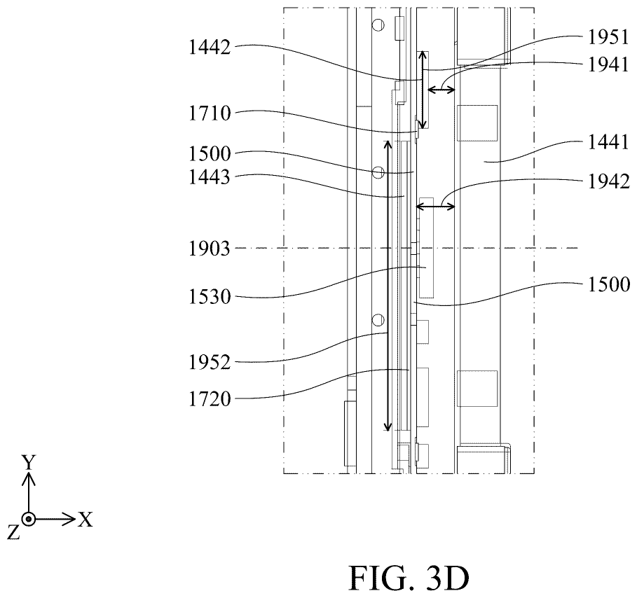

FIG. 2A is a cross-sectional view illustrated along a line A-A in FIG. 1C, and FIG. 2B is a cross-sectional view illustrated along a line B-B in FIG. 1C. FIG. 3A, FIG. 3B, and FIG. 3C are top views of some elements of the optical element driving mechanism 1000, wherein different elements are shown in FIG. 3A, FIG. 3B, and FIG. 3C to further describe the position relationship between the elements. As shown in FIG. 2A to FIG. 3C, the driving assembly 1300 of the optical element driving mechanism 1000 may include a first magnetic element 1310, a second magnetic element 1320, a third magnetic element 1330, a fourth magnetic element 1340, a fifth magnetic element 1350, a sixth magnetic element 1360, a seventh magnetic element 1370, a first coil 1315, a second coil 1325, and a third coil 1335. The first magnetic element 1310, the second magnetic element 1320, the third magnetic element 1330, the fourth magnetic element 1340, the fifth magnetic element 1350, the sixth magnetic element 1360, the first coil 1315, and the second coil 1325 may drive the holder 1210 to move relative to the frame 1220, and the seventh magnetic element 1370 and the third coil 1335 may drive the frame 1220 to move relative to the fixed portion 1100 to achieve auto focus and optical image stabilization.

For example, the first coil 1315 and the second coil 1325 may be disposed on the bottom 1120, and the first magnetic element 1310, the second magnetic element 1320, the third magnetic element 1330, the fourth magnetic element 1340, the fifth magnetic element 1350, and the sixth magnetic element 1360 may be disposed on the frame 1220. Furthermore, the first coil 1315 may correspond to the first magnetic element 1310, the second magnetic element 1320, and the third magnetic element 1330 (such as at least partially overlap each other on the Z axis), and the second coil 1325 may correspond to the fourth magnetic element 1340, the fifth magnetic element 1350, and the sixth magnetic element 1360 (such as at least partially overlap each other on the Z axis) to generate electromagnetic forces in different directions to drive the frame 1220 moving relative to the bottom 1120, thereby achieving optical image stabilization. Moreover, the third coil 1335 may be disposed on the frame 1220, and the seventh magnetic element 1370 may be disposed on the holder 1210 to drive the holder 1210 moving relative to the frame 1220, thereby achieving auto focus. It should be noted that positions of the magnetic elements and the coils are merely examples, and their positions may be interchanged to achieve similar functions, depending on design requirement.

In some embodiments, as shown in FIG. 2A, the first magnetic element 1310, the second magnetic element 1320, and the third magnetic element 1330 may arrange in sequence in the X direction, and the second magnetic element 1320 may be disposed between and in direct with the first magnetic element 1310 and the third magnetic element 1330. In some embodiments, the second magnetic element 1320 is affixed on the first magnetic element 1310 and the third magnetic element 1330.

In some embodiments, the first magnetic element 1310, the second magnetic element 1320, and the third magnetic element 1330 may include a first pair of poles, a second pair of poles, and a third pair of poles (a pair of S pole and N pole), respectively. The first pair of poles, the second pair of poles, and the third pair of poles may arrange along a first pole direction, a second pole direction 1322, and a third pole direction 1332, respectively. The first pole direction, the second pole direction 1322, and the third pole direction 1332 may be different directions, such as the first pole direction and the second pole direction 1322 are not parallel, and the second pole direction 1322 and the third pole direction 1332 are not parallel. Furthermore, the first pole direction and the third pole direction 1332 may be parallel but opposite, such as directed along the −Z direction and the +Z direction, respectively.

By such design, the magnetic field line density of the first magnetic element 1310, the second magnetic element 1320, and the third magnetic element 1330 at a side adjacent to the first coil 1315 may be increased to increase the driving force. Furthermore, the first magnetic element 1310 may have a first magnetic element surface 1311 facing the first coil 1315, and the first pole direction is not parallel to the first magnetic element surface 1311, such as may be perpendicular. The second magnetic element 1320 may have a second magnetic element surface 1321 facing the first magnetic element 1310.

In some embodiments, a first reinforcement element 1510 may be disposed on the first magnetic element 1310, the second magnetic element 1320, and the third magnetic element 1330. The first reinforcement element 1510 may include metal and may include a first opening 1511 and a second opening 1512. The first connecting element 1531 may be disposed through the first opening 1511 to allow the holder 1210 being affixed on the first magnetic element 1310 and the third magnetic element 1330 through the first connecting element 1531, such as may be connected by welding or laser welding, and the first connecting element 1531 may be melted portion caused by the welding or the laser welding. In other words, the first connecting element 1531 may be positioned at the interface of the second magnetic element 1320 and the third magnetic element 1330 and connects to the first reinforcement element 1510 to affix the first magnetic element 1310, the second magnetic element 1320, and the third magnetic element 1330.

In some embodiments, the first connecting element 1531 may be disposed on a surface opposite to the first magnetic element surface 1311, which means the center of the first magnetic element 1310 is between the first connecting element 1531 and the first magnetic element surface 1311. In some embodiments, welding or laser welding may be performed at interfaces between the first reinforcement element 1510 and the first magnetic element 1310, the second magnetic element 1320, and the third magnetic element 1330 to connect the first reinforcement element 1510 to the first magnetic element 1310, the second magnetic element 1320, and the third magnetic element 1330.

Moreover, a second connecting element 1532 may be disposed in the second opening 1512 to connect the first reinforcement element 1510 and the first magnetic element 1310 and the third magnetic element 1330. The first connecting element 1531 and the second connecting element 1532 may arrange in a direction parallel to the first magnetic element surface 1311, such as may arrange in the X direction. The second connecting element 1532 may be, for example, a light-curing adhesive, thermosetting adhesive, moisture-curing adhesive, or AB adhesive (comprising components such as acrylic, epoxy, polyurethane, etc.), but is not limited thereto.

In some embodiments, the first coil 1315 and the first magnetic element 1310, the second magnetic element 1320, and the third magnetic element 1330 corresponding to the first coil 1315 may drive the frame 1220 to move relative to the bottom 1120 in the X axis. Similarly, as shown in FIG. 2B, the second coil 1325 and the fourth magnetic element 1340, the fifth magnetic element 1350, and the sixth magnetic element 1360 corresponding to the second coil 1325 may have similar connecting relationship as the first coil 1315 and the first magnetic element 1310, the second magnetic element 1320, and the third magnetic element 1330 corresponding to the first coil 1315.

For example, the second reinforcement element 1520 may be disposed on the fourth magnetic element 1340, the fifth magnetic element 1350, and the sixth magnetic element 1360, and may connect to the fourth magnetic element 1340, the fifth magnetic element 1350, and the sixth magnetic element 1360 through a third connecting element 1533. The third connecting element 1533 may be disposed in the second reinforcement element 1520 and may connect the second reinforcement element 1520 to the fourth magnetic element 1340 and the sixth magnetic element 1360 through a fourth connecting element 1534. The second coil 1325 and the fourth magnetic element 1340, the fifth magnetic element 1350, and the sixth magnetic element 1360 corresponding to the second coil 1325 may be used for driving the frame 1220 to move relative to the bottom 1120 along the Y axis. Therefore, driving in different axes may be achieved for optical image stabilization. In some embodiments, the first reinforcement element 1510 and the second reinforcement element 1520 may include magnetic permeable material.

In some embodiments, the third coil 1335 and the seventh magnetic element 1370 may be disposed on different sides of the optical element driving mechanism 1000 to the first coil 1315, such as disposed on opposite sides of the holder 1210. In particular, when viewed along a direction perpendicular to the first magnetic element surface 1311 (viewed along the main axis 1900), the first magnetic element 1310 and the seventh magnetic element 1370 are disposed on different sides of the fixed portion 1100 which has a polygonal shape.

The third coil 1335 may be disposed on the frame 1220, and the seventh magnetic element 1370 may be disposed on the holder 1210 to drive the holder 1210 moving relative to the frame 1220 in the Z axis, thereby achieving auto focus. That is to say, the seventh magnetic element 1370 may move relative to the first magnetic element 1310 disposed on the frame 1220. The third coil 1335 may correspond to the seventh magnetic element 1370, such as they may at least overlap each other in the X axis.

To prevent flipping from occurring when the movable portion 1200 is moving, the seventh magnetic element 1370 may be treated as the first force-applying element 1441, such as the seventh magnetic element 1370 and the first force-applying element 1441 may be formed as one piece, and a second force-applying element 1442 may be disposed on a side of the first circuit element 1500 to generate a first leaning force with the first force-applying element 1441 in some embodiments. Furthermore, a third force-applying element 1443 may be disposed on another side of the first circuit element 1500 to generate a second leaning force with the first force-applying element 1441, so the position of the holder 1210 relative to the frame 1220 may be stabilized. The second force-applying element 1442 and the third force-applying element 1443 may include magnetic permeable materials, and may include metal.

In some embodiments, a position sensing assembly may be disposed in the optical element driving mechanism 1000 to detect the positions of the holder 1210 and the frame 1220 relative to the fixed portion 1100, so the movement of the optical element may be detected. For example, as shown in FIG. 2A, FIG. 2B, FIG. 3B, and FIG. 3C, the position sensing assembly may include a first position sensor 1530, a second position sensor 1540, and a third position sensor 1550. The first position sensor 1530 may be disposed on the first circuit element 1500 and electrically connected to the first circuit element 1500. The second position sensor 1540 and the third position sensor 1550 are disposed on the bottom 1120 and may electrically connected to the circuits in the bottom 1120.

In some embodiments, the first position sensor 1530 may be disposed in the third coil 1335 to detect the magnetic field of the seventh magnetic element 1370, so the positions of the seventh magnetic element 1370 and the holder 1210 may be detected. The second position sensor 1540 may be disposed in the first coil 1315 to detect the magnetic field of the first magnetic element 1310, the second magnetic element 1320, and the third magnetic element 1330, so the positions of the first magnetic element 1310, the second magnetic element 1320, the third magnetic element 1330, and the frame 1220 relative to the fixed portion 1100 may be detected. The third position sensor 1550 may be disposed in the second coil 1325 to detect the magnetic field of the fourth magnetic element 1340, the fifth magnetic element 1350, and the sixth magnetic element 1360, so the positions of the fourth magnetic element 1340, the fifth magnetic element 1350, the sixth magnetic element 1360, and the frame 1220 may be detected.

In some embodiments, the first position sensor 1530, the second position sensor 1540, and the third position sensor 1550 may include a Hall sensor, a magnetoresistance effect sensor (MR sensor), a giant magnetoresistance effect sensor (GMR sensor), a tunneling magnetoresistance effect sensor (TMR sensor), or a fluxgate sensor.

In some embodiments, as shown in FIG. 3C, in a direction that the second axis 1902 extends (the Y direction), a shortest distance 1932 between the center of the third force-applying element 1443 and a center 1920 of the frame 1220 may be different from a shortest distance 1931 between the center of the second force-applying element 1442 and the center 1920 of the movable portion 1200. For example, the shortest distance 1932 between the center of the third force-applying element 1443 and a center 1920 of the frame 1220 may be less than the shortest distance 1931 between the center of the second force-applying element 1442 and the center 1920 of the movable portion 1200.

Furthermore, FIG. 3D is an enlarged view of an area 1960 of FIG. 3C. As shown in FIG. 3D, in a direction that the third axis 1903 extends (the X direction), a shortest distance 1941 between the first force-applying element 1441 and the second force-applying element 1442 is different from a shortest distance 1942 between the first force-applying element 1441 and the third force-applying element 1443, such as the shortest distance 1941 between the first force-applying element 1441 and the second force-applying element 1442 is less than the shortest distance 1942 between the first force-applying element 1441 and the third force-applying element 1443. Furthermore, a maximum size 1951 of the second force-applying element 1442 at the third axis 1903 is different from a maximum size 1952 of the third force-applying element 1443 at the third axis 1903, such as the maximum size 1951 of the second force-applying element 1442 at the third axis 1903 is less than the maximum size 1952 of the third force-applying element 1443 at the third axis 1903. In some embodiments, when viewed along the main axis 1900, the second force-applying element 1442 is between the first force-applying element 1441 and the first circuit element 1500. Moreover, the first position sensor 1530 and the second force-applying element 1442 may arrange along the second axis 1902.

In some embodiments, a first adhesive element 1710 and a second adhesive element 1720 may be disposed on the first circuit element 1500 to affix the second force-applying element 1442 and the third force-applying element 1443 on the first circuit element 1500, respectively. In some embodiments, the first adhesive element 1710 may include metal, such may be solder, and the electrical signal of the first circuit element 1500 does not pass through the second force-applying element 1442 (rather than grounding). In other words, the second force-applying element 1442 and the driving assembly 1300 may be electrically isolated from each other to pre may prevent interference of the signal and prevent short circuit. The second adhesive element 1720 may include insulating material, such as may include resin, light-curing adhesive, thermosetting adhesive, moisture-curing adhesive, or AB adhesive (comprising components such as acrylic, epoxy, polyurethane, etc.), but it is not limited thereto.

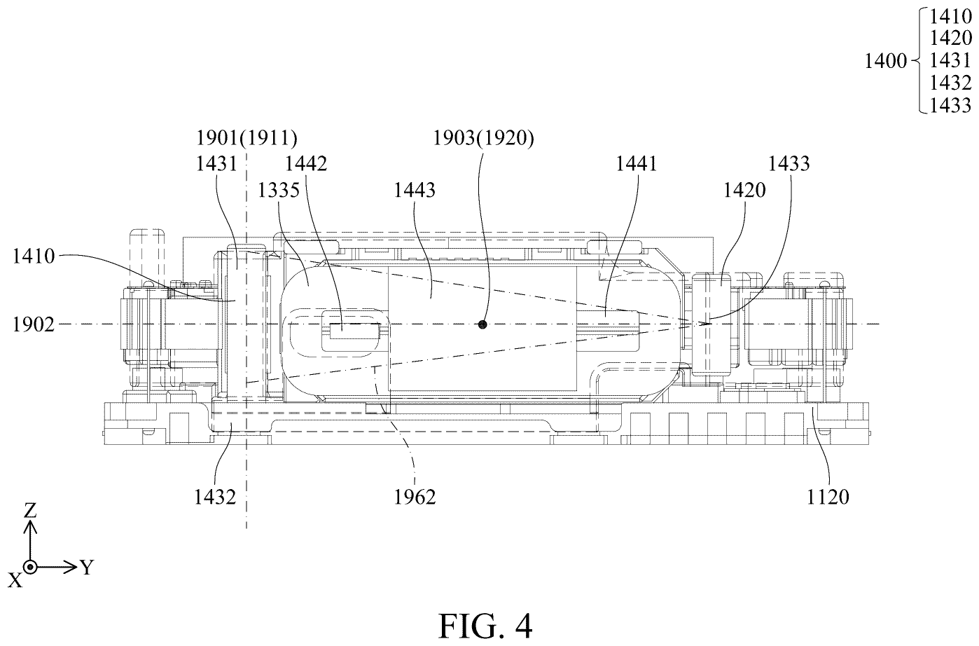

FIG. 4 is a side view of some elements of the optical element driving mechanism 1000. As shown in FIG. 4, when viewed along the third axis 1903 (the X axis), the second force-applying element 1442 does not overlap the third force-applying element 1443, and the third coil 1335 does not overlap the second force-applying element 1442. Therefore, the size in the X axis may be reduced to achieve miniaturization. Furthermore, when viewed along the third axis 1903, the area of the second force-applying element 1442 is different from the area of the third force-applying element 1443, such as the area of the second force-applying element 1442 is less than the area of the third force-applying element 1443. The second force-applying element 1442 is smaller, so the leaning force generated by the second force-applying element 1442 does not affect the normal operation of the optical element driving mechanism 1000 too much.

In some embodiments, as shown in FIG. 4, the holder 1210 may be movably connected to the frame 1220 through the first supporting assembly 1400. For example, the first supporting assembly 1400 may include a first moving portion 1410, a second moving portion 1420, a first contact portion 1431, a second contact portion 1432, and a third contact portion 1433. The first contact portion 1431 and the third contact portion 1433 may be a portion of the frame 1220, and the second contact portion 1432 may be a portion of the bottom 1120.

In particular, the first moving portion 1410 may be disposed between the first contact portion 1431 and the second contact portion 1432 to be in direct contact with the first contact portion 1431 and the second contact portion 1432, and the first moving portion 1410 is movable relative to the first contact portion 1431. The second moving portion 1420 may be disposed in the third contact portion 1433 to be in direct contact with the third contact portion 1433, and the second moving portion 1420 is movable relative to the third contact portion 1433. In some embodiments, the first moving portion 1410 and the second moving portion 1420 may be column-shaped and extend along the first axis 1901 (the Z axis). In some embodiments, the first moving portion 1410 and the second moving portion 1420 may also have a ball-typed structure, such as may include a plurality of balls arranged along the Z axis. As a result, the movable portion 1200 may move relative to the fixed portion 1100 in a first dimension (movement parallel to the Z axis) through the first supporting assembly 1400.

As shown in FIG. 4, the first contact portion 1431 and the second contact portion 1432 may arrange along the first axis 1901, and a connection between centers of the first contact portion 1431 and the second contact portion 1432 may be defined as a first virtual line 1911. In some embodiments, in the direction that the first axis 1901 extends (the Z direction), the first moving portion 1410 does not overlap the second moving portion 1420. Moreover, in the direction that the second axis 1902 extends (the Y direction), the first moving portion 1410 at least partially overlap the second moving portion 1420. In the direction that the third axis 1903 extends (the X direction), the first moving portion 1410 does not overlap the second moving portion 1420. In some embodiments, the first axis 1901, the second axis 1902, and the third axis 1903 are not parallel, such as may be perpendicular. Therefore, the size of the optical element driving mechanism 1000 in specific directions may be reduced to achieve miniaturization.

In some embodiments, in the direction that the second axis 1902 extends, the center of the second force-applying element 1442 is between the first virtual line 1911 and the center of the movable portion 1200. Furthermore, as shown in FIG. 4, when viewed along the third axis 1903, the center of the second force-applying element 1442 is in a triangle formed by the centers of the first contact portion 1431, the second contact portion 1432, and the third contact portion 1433. Therefore, the torque caused by the second force-applying element 1442 to the movable portion 1200 may be reduced to prevent undesired flip when the optical element driving mechanism 1000 is moving, so the driving accuracy may be enhanced.

In summary, an optical element driving mechanism is provided, which includes a movable portion, a fixed portion, and a driving assembly. The movable portion is used for connecting an optical element. The movable portion is movable relative to the fixed portion. The driving assembly is used for driving the movable portion to move relative to the fixed portion. Therefore, functions such as auto focus, optical image stabilization, zooming, and miniaturization may be achieved.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. An optical element driving mechanism, comprising:
a movable portion used for connecting an optical element;
a fixed portion, wherein the movable portion is movable relative to the fixed portion; and
a driving assembly used for driving the movable portion to move relative to the fixed portion.

2. The optical element driving mechanism as claimed in claim 1, further comprising a first supporting assembly, wherein:
the movable portion is movable relative to the fixed portion in a first dimension through the first supporting assembly;
the first supporting assembly comprises:
a first moving portion;
a first contact portion movable relative to the first moving portion and in contact with the first moving portion;
a second contact portion movable relative to the first moving portion and in contact with the first moving portion;
a second moving portion; and
a third contact portion movable relative to the second moving portion and in contact with the second moving portion.

3. The optical element driving mechanism as claimed in claim 2, wherein:
a connection between centers of the first contact portion and the second contact portion is defined as a first virtual line;
the first contact portion and the second contact portion are arranged along a first axis;
the first moving portion and the second moving portion do not overlap each other in a direction that the first axis extends;
the first moving portion and the second moving portion at least partially overlap each other in a direction that a second axis extends;
the first moving portion and the second moving portion do not overlap each other in a direction that a third axis extends.

4. The optical element driving mechanism as claimed in claim 3, wherein:
the first axis and the second axis are not parallel;
the first axis and the third axis are not parallel;
the second axis and the third axis are not parallel.

5. The optical element driving mechanism as claimed in claim 4, further comprising:
a first force-applying element;
a second force-applying element corresponding to the first force-applying element to generate a first leaning force; and
a third force-applying element corresponding to the first force-applying element to generate a second leaning force.

6. The optical element driving mechanism as claimed in claim 5, wherein:
a center of the second force-applying element is between the first virtual line and a center of the movable portion in the direction that the second axis extends;
the center of the second force-applying element is in a triangle formed by centers of the first contact portion, the second contact portion, and the third contact portion when viewed along the third axis.

7. The optical element driving mechanism as claimed in claim 6, wherein:
a shortest distance between a center of the third force-applying element and the center of the movable portion is different from a shortest distance between the center of the second force-applying element and the center of the movable portion in the direction that the second axis extends;
a shortest distance between the first force-applying element and the second force-applying element is different from a shortest distance between the first force-applying element and the third force-applying element in the direction that the third axis extends.

8. The optical element driving mechanism as claimed in claim 7, wherein:
the first axis is perpendicular to the second axis;
the first axis is perpendicular to the third axis;
the second axis is perpendicular to the third axis.

9. The optical element driving mechanism as claimed in claim 8, wherein:
the shortest distance between the center of the third force-applying element and the center of the movable portion is less than the shortest distance between the center of the second force-applying element and the center of the movable portion in the direction that the second axis extends;
the shortest distance between the first force-applying element and the second force-applying element is less than the shortest distance between the first force-applying element and the third force-applying element in the direction that the third axis extends;
the second force-applying element and the third force-applying element do not overlap each other in the direction that the third axis extends.

10. The optical element driving mechanism as claimed in claim 9, further comprising a first circuit element and a first adhesive element, wherein:
the first circuit element is electrically connected to the driving assembly;
the second force-applying element is between the first force-applying element and the first circuit element when viewed along the first axis;
the second force-applying element connects to the first circuit element through the first adhesive element;
the first adhesive element comprises metal.

11. The optical element driving mechanism as claimed in claim 10, further comprising a second adhesive element, wherein:
electrical signal in the first circuit element does not pass through the second force-applying element;
the second force-applying element is electrically isolated from the driving assembly;
the second force-applying element comprises metal;
the third force-applying element connects to the first circuit element through the second adhesive element;
the second adhesive element comprises resin;
the third force-applying element comprises metal.

12. The optical element driving mechanism as claimed in claim 11, wherein:
an area of the second force-applying element is different from an area of the third force-applying element when viewed along the third axis;
a maximum size of the second force-applying element in the third axis is different from a maximum size of the third force-applying element in the third axis.

13. The optical element driving mechanism as claimed in claim 1, wherein the driving assembly comprises:
a first coil;
a first magnetic element having a first magnetic element surface facing the first coil, and having a first pair of poles arranged along a first pole direction;
a second magnetic element adjacent to the first magnetic element and having a second pair of poles arranged along a second pole direction; and
a third magnetic element having a third pair of poles arranged along a third pole direction.

14. The optical element driving mechanism as claimed in claim 13, wherein:
the first pole direction is not parallel to the first magnetic element surface;
the second pole direction is not parallel to the first pole direction;
the second magnetic element is affixed on the first magnetic element;
a second magnetic element surface of the second magnetic element faces the first magnetic element;
the first pole direction and the third pole direction are parallel and opposite.

15. The optical element driving mechanism as claimed in claim 14, further comprising:
a first connecting element, wherein the first magnetic element is affixed on the second magnetic element through the first connecting element; and
a first reinforcement element comprises metal and corresponds to the first magnetic element.

16. The optical element driving mechanism as claimed in claim 15, wherein:
the first connecting element is located at an intersection between the first magnetic element and the second magnetic element;
a center of the first magnetic element is between the first connecting element and the first magnetic element surface;
the first connecting element connects to the first reinforcement element;
the first connecting element is in a first opening of the first reinforcement element;
the first reinforcement element is magnetic permeable.

17. The optical element driving mechanism as claimed in claim 16, further comprises a second connecting element connects to the first magnetic element;
wherein:
the first connecting element and the second connecting element are arranged along a direction parallel to the first magnetic element surface;
the second connecting element is in a second opening of the first reinforcement element.

18. The optical element driving mechanism as claimed in claim 17, wherein:
the second connecting element connects to the first reinforcement element;
the second magnetic element at least partially overlaps the first coil in a direction perpendicular to the first magnetic element surface.

19. The optical element driving mechanism as claimed in claim 18, wherein the driving assembly further comprises:
a third coil; and
a seventh magnetic element corresponding to the third coil;
wherein:
the seventh magnetic element is movable relative to the first magnetic element;
the first magnetic element and the seventh magnetic element are disposed on different sides of the fixed portion having a polygonal shape when viewed in the direction perpendicular to the first magnetic element surface.

20. The optical element driving mechanism as claimed in claim 19, further comprising a position sensing assembly, a first circuit element, and a second force-applying element, wherein:
the position sensing assembly is used for detecting movement of the optical element;
the position sensing assembly comprises a first position sensor;
the movable portion and the fixed portion are arranged along a first axis;
the first position sensor and the second force-applying element are arranged along a second axis;
the first axis and the second axis are perpendicular;
the first position sensor is disposed on the first circuit element.
